(19) United States
(12) Patent Application Publication
(10) Pub. No.: US 2026/0225517 A1
(43) Pub. Date: Aug. 6, 2026

(54) LAMP CONTROL SYSTEM, LAMP CONTROL METHOD, AND MOVING OBJECT

(71) Applicant: HYUNDAI MOBIS CO., LTD., Seoul (KR)

(72) Inventor: Jun Young SUNG, Yongin-si (KR)

(73) Assignee: HYUNDAI MOBIS CO., LTD., Seoul (KR)

(21) Appl. No.: 19/312,526

(22) Filed: Aug. 28, 2025

(30) Foreign Application Priority Data
Feb. 4, 2025 (KR) 10-2025-0013628

(51) Int. Cl. B60Q 1/14; H05B 47/115; H05B 47/16

(52) U.S. Cl. CPC B60Q 1/143; H05B 47/115; H05B 47/16; B60Q 2300/054; B60Q 2300/112; B60Q 2300/305; B60Q 2300/41

(57) ABSTRACT

A lamp control system for a moving object includes a lamp to emit a beam pattern, and a processor to adjust a light amount of the beam pattern depending on a degree of road traffic congestion. The processor controls the light amount of the beam pattern to be lower as the degree of road traffic congestion increases.

### CROSS-REFERENCE TO RELATED APPLICATIONS

Pursuant to 35 U.S.C. § 119(a), this application claims the benefit of earlier filing dates and right of priority to Korean Application No. 10-2025-0013628, filed on Feb. 4, 2025, the contents of which are hereby incorporated by reference herein in their entirety.

### BACKGROUND

### Field

The present disclosure relates to a lamp control system, a lamp control method, and a moving object, and more particularly, to a lamp control system, a lamp control method, and a moving object configured to control the amount of light of a lamp.

### Discussion of the Related Art

A low beam of a lamp is one of lighting modes used in a vehicle headlight, and is a light source optimized for illuminating close distances. A main function of the low beam is to ensure a field of vision of a driver during night driving or in a dark environment, while at the same time minimizing glare to oncoming vehicles or drivers of vehicles in front.

A light pattern for a low beam is designed to have a clear upper edge of light and not blind oncoming vehicles.

Accordingly, the present disclosure provides a method of controlling a light amount of a low beam of a lamp according to a driving environment of a user or driver of a car or a moving object (hereinafter referred to as “driver driving environment”). In this specification, the driver driving environment may include information about a driving environment, such as a driving record of a moving object or a car in a road traffic congestion section, a driving record on a highway section, or a driving record on a general road section. The driver driving environment includes information related to a driving purpose or use of the car or moving object, and may include information related to, for example, whether separate driving is a repetitive type of driving such as commuting to and from work, whether separate driving is for leisure, whether separate driving is accompanied by passengers other than the user or driver, and whether there are people getting on or off during the separate driving.

### SUMMARY

An object of the present disclosure is to provide a lamp control system configured to control a light amount of a lamp, a vehicle including the lamp control system, or a method therefor.

An object of the present disclosure is to provide a lamp control system configured to control a light amount of a lamp by using information related to a driver driving environment during control of the lamp, a vehicle including the lamp control system, or a method therefor.

The objects of the present disclosure are not limited to the objects described above. Other objects not described above may be understood by those of skill in the art from the description of the present disclosure below.

According to an embodiment of the present disclosure, a lamp control system for a moving object includes a lamp configured to emit a beam pattern, and a processor configured to adjust a light amount of the beam pattern depending on a degree of road traffic congestion, wherein the processor is configured to control the light amount of the beam pattern to be lower as the degree of road traffic congestion increases.

Additionally or alternatively, the processor may be configured to initiate adjustment of the light amount of the beam pattern when a set destination of navigation for the moving object is a specific location.

Additionally or alternatively, the processor may be configured to initiate adjustment of the light amount of the beam pattern based on a current time being within a road traffic congestion time zone and a road section on which the moving object drives being a road traffic congestion section, and information on the road traffic congestion time zone and the road traffic congestion section may be obtained based on driving data of a plurality of moving objects.

Additionally or alternatively, the processor may be configured to obtain a driving ratio in a road traffic congestion section based on driving record analysis data of the moving object or a driver of the moving object, determine whether the driving ratio in the road traffic congestion section exceeds a reference value, and initiate adjustment of the light amount of the beam pattern based on the driving ratio in the road traffic congestion section exceeding the reference value.

Additionally or alternatively, the processor may be configured to control the light amount of the beam pattern to be lower as a driving speed of the moving object decreases.

Additionally or alternatively, a degree of reduction in the light amount of the beam may be set to be greater as the driving ratio in the road traffic congestion section becomes higher.

Additionally or alternatively, the processor may be configured to determine whether there is the road traffic congestion or the degree of road traffic congestion based on any one of an average driving speed of the moving object, an average inter-moving object distance during driving of the moving object, and an average number of moving objects ahead during driving of the moving object.

Additionally or alternatively, the processor may be configured to control the light amount of the beam pattern to be lower as the average driving speed of the moving object becomes lower, the average inter-moving object distance during driving of the moving object becomes shorter, and the average number of moving objects ahead during driving of the moving object becomes higher.

According to another embodiment of the present disclosure, a lamp control method for a moving object, which is performed by a lamp control system including a lamp configured to emit a beam pattern includes obtaining a degree of road traffic congestion, and controlling a light amount of the beam pattern to be lower as the degree of road traffic congestion increases.

The lamp control method may include initiating adjustment of the light amount of the beam pattern when a set destination of navigation for the moving object is a specific location.

The lamp control method may include initiating adjustment of the light amount of the beam pattern based on a current time being within a road traffic congestion time zone and a road section on which the moving object drives being a road traffic congestion section, and information on the road traffic congestion time zone and the road traffic congestion section may be obtained based on driving data of a plurality of moving objects.

The lamp control method may include obtaining a driving ratio in a road traffic congestion section based on driving record analysis data of the moving object; determining whether the driving ratio in the road traffic congestion section exceeds a reference value; and initiating adjustment of the light amount of the beam pattern based on the driving ratio in the road traffic congestion section exceeding the reference value.

The lamp control method may include controlling the light amount of the beam pattern to be lower as a driving speed of the moving object decreases.

A degree of reduction in the light amount of the beam may be set to be greater as the driving ratio in the road traffic congestion section becomes higher.

The lamp control method may include determining whether there is the road traffic congestion or the degree of road traffic congestion based on any one of an average driving speed of the moving object, an average inter-moving object distance during driving of the moving object, and an average number of moving objects ahead during driving of the moving object.

The lamp control method may include controlling the light amount of the beam pattern to be lower as the average driving speed of the moving object becomes lower, the average inter-moving object distance during driving of the moving object becomes shorter, and the average number of moving objects ahead during driving of the moving object becomes higher.

According to another embodiment of the present disclosure, a moving object includes a lamp configured to emit a beam pattern, and a lamp control system including a processor configured to adjust a light amount of the beam pattern depending on a degree of road traffic congestion, wherein the processor is configured to control the light amount of the beam pattern to be lower as the degree of road traffic congestion increases.

The processor may be configured to initiate adjustment of the light amount of the beam pattern when a set destination of navigation for the moving object is a specific location.

The processor may be configured to initiate adjustment of the light amount of the beam pattern based on a current time being within a road traffic congestion time zone and a road section on which the moving object drives being a road traffic congestion section, and information on the road traffic congestion time zone and the road traffic congestion section may be obtained based on driving data of a plurality of moving objects.

The processor may be configured to obtain a driving ratio in a road traffic congestion section based on driving record analysis data of the moving object, determine whether the driving ratio in the road traffic congestion section exceeds a reference value, and initiate adjustment of the light amount of the beam pattern based on the driving ratio in the road traffic congestion section exceeding the reference value.

The solution of the present disclosure is a part of the embodiments of the present disclosure. Various solution means other than the solution means of the above objects may be derived and understood based on the detailed description of the present disclosure to be described below.

### BRIEF DESCRIPTION OF THE DRAWINGS

The accompanying drawings, which are incorporated in and are intended to aid in the understanding of the present disclosure and are intended to illustrate embodiments of the present disclosure and, together with the detailed description, serve to explain the present disclosure.

FIG. 1 is a block diagram of an autonomous vehicle to which an autonomous driving device is applicable.

FIG. 2 is a diagram showing an example of an autonomous driving device applied to a vehicle.

FIG. 3 is a block diagram of a lamp control system according to the present disclosure.

FIG. 4 shows data collected and analyzed on a degree of congestion in a road section according to the present disclosure.

FIG. 5 is a flowchart of a method of controlling the amount of light of a beam pattern according to the present disclosure.

FIG. 6 is a flowchart illustrating a first method for determining whether an activation condition of a beam pattern light amount reduction control mode is satisfied according to the present disclosure.

FIG. 7 illustrates a flowchart of a first method for determining whether a driving section is a road traffic congestion section according to the present disclosure.

FIG. 8 is a flowchart illustrating a second method for determining whether an activation condition of a beam pattern light amount reduction control mode is satisfied according to the present disclosure.

FIG. 9 illustrates a flowchart of a second method for determining whether a driving section is a road traffic congestion section according to the present disclosure.

FIG. 10 illustrates a flowchart of a third method for determining whether a driving section is a road traffic congestion section according to the present disclosure.

### DETAILED DESCRIPTION

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein. In the drawings, parts that are not related to a description of the present disclosure are omitted to clearly explain the present disclosure and similar reference numbers will be used throughout this specification to refer to similar parts.

In the specification, when a part “includes” an element, it means that the part may further include another element rather than excluding another element unless otherwise mentioned.

In addition, in the specification, “occupant”, “passenger”, “driver”, “user”, etc. are mentioned for description of the present disclosure, and may be used interchangeably therewith.

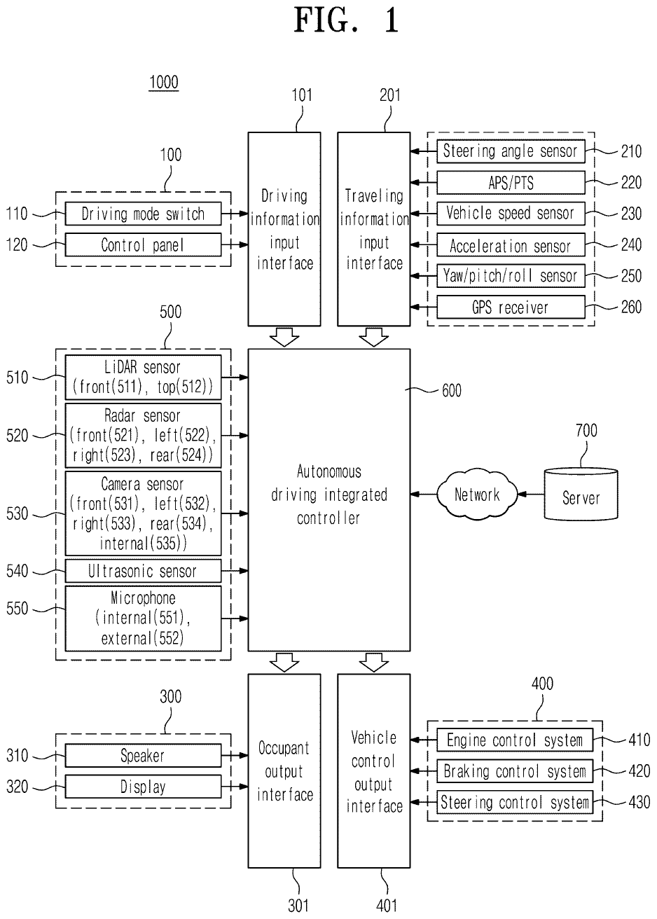

FIG. 1 is an overall block diagram of an autonomous driving control system to which an autonomous driving apparatus according to any one of embodiments of the present disclosure is applicable.

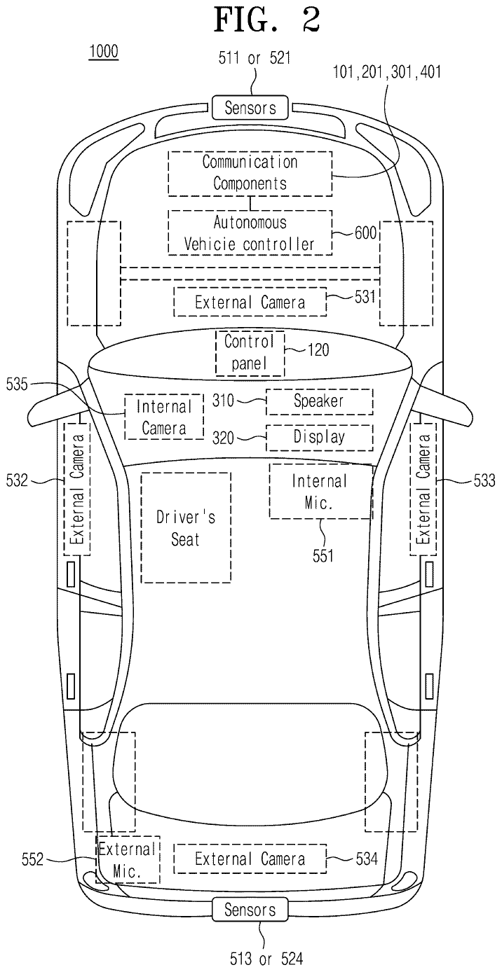

FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LIDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on Al or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

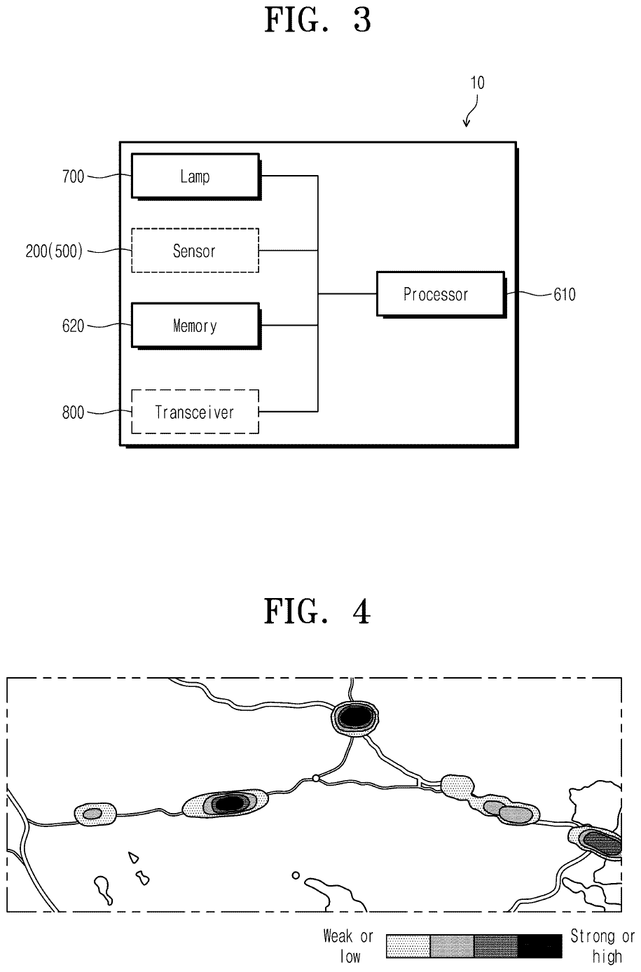

FIG. 3 illustrates a block diagram of a lamp control system according to the present disclosure.

A lamp control system 10 may include a lamp 700, a memory 620, and a processor 610. The lamp control system 10 may be included in a moving object 1000 and may be mounted or installed in the moving object 1000. In this specification, the moving object means an object that has mobility as a transportation, and may include, for example, a vehicle, a drone, and a robot.

The lamp 700 is a type of output unit that irradiates a beam in a front direction of a moving object according to a beam pattern and may be formed in a pair. In more detail, the lamp 700 may include a pair of headlamps on a left front and right front based on the moving object (or vehicle). In general, a headlamp or a headlight may include a low beam, a high beam, a turn signal, a daytime driving light, and a side light.

The lamp 700 may include a turn signal lamp, referred to as a turn signal. The turn signal lamp may output a turn signal to notify rear or oncoming vehicles, pedestrians, or the like that a moving object is about to change lanes or enter or exit a lane.

The memory 620 may be configured to store the following information.

### 1) Navigation Destination

The memory 620 may store navigation data of a moving object 1000. Additionally or alternatively, the memory 620 may be configured to store information about a starting point or destination of navigation of the moving object 1000. In more detail, information about the starting point or destination may include location information of the home or workplace (company) of a user of the moving object 1000. The location information of the home or workplace (company) of the user may be information preset by the user of the moving object 1000.

When the moving object 1000 is used by a plurality of users (for example, when a couple uses one moving object), the lamp control system 10 may identify each user, and the user identification may be performed directly by the lamp control system 10 or by obtaining only a result of identification performed by another system within the moving object 1000. If user identification is possible, the memory 620 may be configured to store information about the starting point or destination for each user.

### 2) Information on Road Traffic Congestion Section

The memory 620 may be configured to store information about a road traffic congestion section. The information about the road traffic congestion section may be information obtained by analyzing driving data of a plurality of moving objects.

Prior to that, the lamp control system 10 may be configured to receive the information on the road traffic congestion section from a server.

The information about the road traffic congestion section may include information indicating a degree of congestion on a separate road section, such as an average driving speed for each road section by hour, and a time required to pass through a road section by hour. The server may collect driving data from a plurality of moving objects and analyze the driving data to form big data. For example, it is possible to obtain information on a road section on which each moving object drives, driving time information, average driving speed, or a time required to pass through a road section, and information indicating a degree of congestion for separate road section. An example of big data indicating a degree of congestion in a road section according to the present disclosure is illustrated in FIG. 4.

As seen from FIG. 4, a degree of congestion is indicated by hatching on a map. Information shown in FIG. 4 is obtained by collecting, analyzing, and refining a driving distance of a plurality of objects and displayed.

### 3) Subject Moving Object Analysis Data

The memory 620 may be configured to store analysis data obtained by analyzing the driving record of the moving object 1000. Driving record analysis data may include information on a driving ratio of the moving object 1000 in the road traffic congestion section and information on a driver driving environment of the moving object 1000.

Hereinafter, “analysis data” is described in more detail.

The memory 620 may be configured to store information about the driving ratio of the moving object 1000 in the road traffic congestion section of the moving object 1000. The information on the driving ratio of the moving object 1000 in the road traffic congestion section includes a ratio of sections in which congestion occurs from among the entire driving road sections of the moving object 1000. Congestion means that an average driving speed on a separate road section is less than a reference speed or a time required to pass through the separate road section is less than a reference time.

Additionally or alternatively, the memory 620 may be configured to store information about the driver driving environment of the moving object 1000. The information about the driver driving environment may also include information about a proportion of a specific driver driving environment in entire driving.

For example, if a driving environment represents driving on a highway section, information about the driving environment may include information representing a proportion of driving on a highway section in the entire driving of the moving object 1000.

As described above, the information about the driver driving environment may include information about a driving environment, such as a driving record of a moving object or a car in a road traffic congestion section, a driving record on a highway section, or a driving record on a general road section.

The information about the driver driving environment includes information related to a driving purpose or use of the car or moving object, and may include information related to, for example, whether separate driving is a repetitive type of driving such as commuting to and from work, whether separate driving is for leisure, whether separate driving is accompanied by passengers other than the user or driver, and whether there are people getting on or off during the separate driving. The information about the driver driving environment is only an example, and the present disclosure is not limited to specific information.

The information on the driving ratio of the moving object 1000 in the road traffic congestion section or the information on the driver driving environment of the moving object 1000 described above may be information collected and analyzed by the moving object 1000 or a processor included in the moving object 1000.

The information on the driving ratio of the moving object 1000 in the road traffic congestion section or the information on the driver driving environment of the moving object 1000 described above may be collected and analyzed by a device external to the moving object 1000, such as a server. In this case, the lamp control system 10 may be configured to receive from the server information on the driving ratio in the road traffic congestion section or information on the driver driving environment of the moving object 1000.

The “road traffic congestion section information” or “analysis data” that is to be stored in the memory 620 described above may be combined and used when controlling the amount of light of the lamp control system 10. To explain in more detail, before sufficient analysis data for the moving object 1000 is collected, the lamp control system 10 may perform lamp light amount control by using “road traffic congestion section information” (i.e., driving data of other vehicles/cars, or the like). Once sufficient analysis data for the moving object 1000 is collected, the lamp control system 10 may perform lamp light amount control by using the “analysis data” (i.e., information obtained by analyzing the driving data of the moving object 1000).

As an example of the information about the road traffic congestion section, the following data may be obtained.

TABLE 1

| Road section | Time zone (hours) | Degree of congestion |
|---|---|---|
| P1 | 1 to 6 | Low |
| | 6 to 9 | High |
| | 9 to 14 | Medium |
| | . . . | . . . |
| P2 | 1 to 6 | Low |
| | 6 to 9 | Medium |
| | 9 to 14 | Medium |
| | . . . | . . . |
| . . . | . . . | . . . |

As an example of analysis data of the moving object 1000, the following data may be obtained.

TABLE 2

| Congested/non-congested section driving ratio of moving | Percentage |
|---|---|
| object 1000 | value (%) |
| Ratio of Congested section | 25 |
| Ratio of Non-congested section | 75 |

The processor 610 may be configured to collect information to be stored in the memory 620 described above. The processor 610 may be configured to control the amount of light of a beam pattern by using the information stored in the memory 620.

The “road traffic congestion section information” described above may include data obtained by collecting or analyzing information on an unspecified moving object. Therefore, it may be necessary to specify the road traffic congestion section information to be used for the moving object 1000.

As an example, the road traffic congestion section information for the moving object 1000 may be specified as road traffic congestion section information that corresponds to or matches the characteristics of the moving object 1000 from road traffic congestion section information of other moving objects.

For example, the characteristics of the moving object 1000 may include at least one of a size class (segment class), a model name, or the maximum load capacity of the moving object 1000 and the characteristics of the moving object 1000 may not limit the scope of the present disclosure. For example, if the moving object 1000 is a moving object of segment D, the road traffic congestion section information of segment D may be used from the road traffic congestion section information stored in the memory 620.

The processor 610 may use information on a degree of road traffic congestion to control the amount of light in the beam pattern.

The photosensitivity of the beam pattern depending on the degree of road traffic congestion may be set as follows.

TABLE 3

| | Degree of road traffic | Photosensitivity |
|---|---|---|
| No. | congestion | (k = reference light amount) |
| 1 | Low | 0.1* k |
| 2 | Medium | 0.3* k |
| 3 | High | 0.5* k |
| . . . | . . . | . . . |

The photosensitivity in Table 3 is an example and is configured to be higher as a degree of road traffic congestion becomes stronger (severe).

The photosensitivity of the lamp may be set to increase as the degree of road traffic congestion increases (severe). A function of a low beam of the lamp is limited in traffic jams, and thus the photosensitivity is set to a large level. In Table 3, k represents a reference light amount and represents the light amount of a low beam of a lamp when the light amount of the beam pattern according to the present disclosure is not controlled.

Additionally or alternatively, the processor 610 may use analysis data of the driving record of the moving object 1000 to control the amount of light of the beam pattern. That is, the processor 610 may control the amount of light of the beam pattern by using analysis data of the driving record of the moving object 1000, such as information on the driving ratio of the moving object 1000 in the road traffic congestion section described above or information on the driver driving environment of the moving object 1000.

As an example, a light reduction amount of a lamp of the lamp control system 10 may be determined according to a driving ratio in a congested section of the moving object 1000 as follows.

TABLE 4

| | Congested section driving | Photosensitivity (k = |
|---|---|---|
| No | ratio (%) | reference light amount) |
| 1 | 0 or more and less than 20 | 0.1* k |
| 2 | 20 or more and less than 45 | 0.15* k |
| 3 | 45 or more and less than 70 | 0.25* k |
| 4 | 70 or more | 0.30* k |

The photosensitivity in Table 4 is an example and is configured to be higher as a congested section driving ratio increases.

The photosensitivity in Table 4 is different information from the photosensitivity in Table 3. Accordingly, when the degree of road traffic congestion on the road section on which the moving object 1000 drives and the driving ratio information of the moving object 1000 in the congested section are set to be used in lamp light amount control, the two photosensitivities may be combined. For example, if the congested section driving ratio of the moving object 1000 may be 2 and a degree of congestion of the road section on which the moving object 1000 currently drives is 3, the luminous intensity of the lamp may be controlled to be reduced by (0.15+0.5)*k=0.65*k.

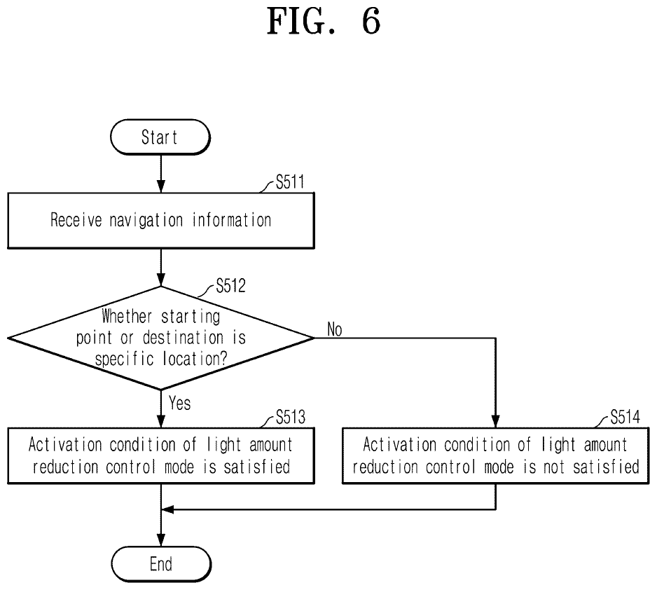

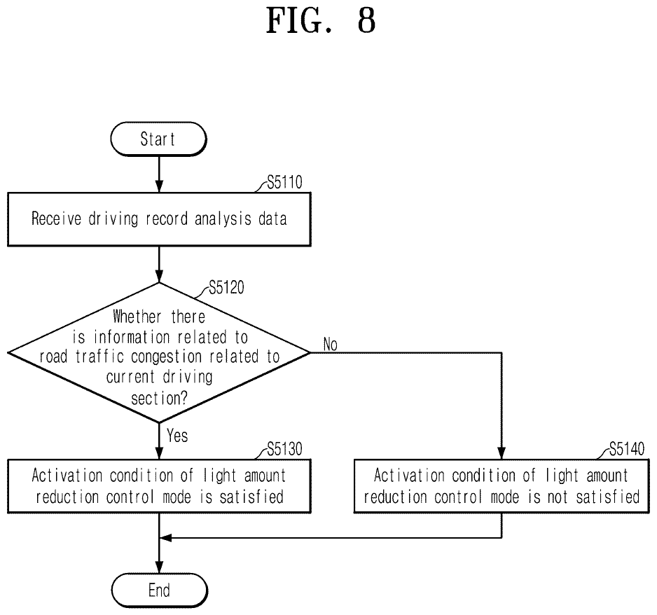

Before the processor 610 controls a beam pattern light amount by using information stored in the memory 620, the processor 610 may be configured to determine whether an activation condition of a beam pattern light amount reduction control mode is satisfied. When the activation condition of the beam pattern light amount reduction control mode is satisfied, the processor 610 may be configured to initiate adjustment of the amount of light of the beam pattern. This will be described below with reference to FIG. 6 or 8.

The lamp control system 10 may further include a sensor 200 or 500. The sensor may include sensors 210, 220, 230, 240, 250, and 260 configured to obtain information related to driving of a moving object or sensors 510, 520, 530, and 540 configured to obtain information about surroundings of the moving object. The current location information of the moving object 1000 may be obtained through the sensor.

The lamp control system 10 may further include a transceiver 800. The transceiver 800 may be configured to receive from a server at least one of information on the driving ratio in a road traffic congestion section or information on the driver driving environment of the moving object 1000. The transceiver 800 may be configured to transmit to the server the driving record or driving information of the moving object 1000 equipped with or installed with the lamp control system 10.

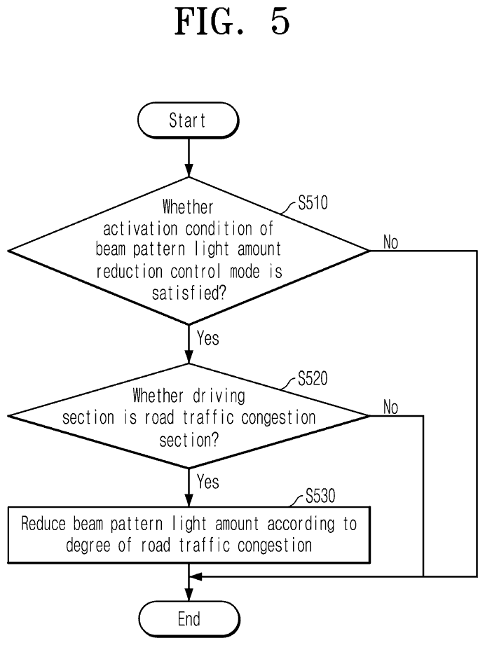

FIG. 5 is a flowchart of a method of controlling the amount of light of a beam pattern according to the present disclosure. light amount reduction control of the illustrated beam pattern may be performed by the light amount reduction control or the moving object 1000 including the lamp control system 10. For simplicity of explanation, the method illustrated below is described as being performed by the lamp control system 10.

The lamp control system 10 may determine whether the activation condition of the beam pattern light amount reduction control mode is satisfied (S510). Only when the activation condition is satisfied, a subsequent procedure may proceed. The activation condition will be described below with reference to FIG. 6 or 8.

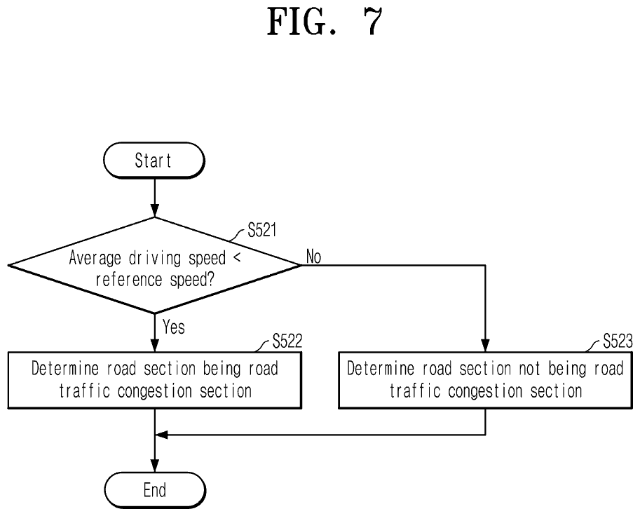

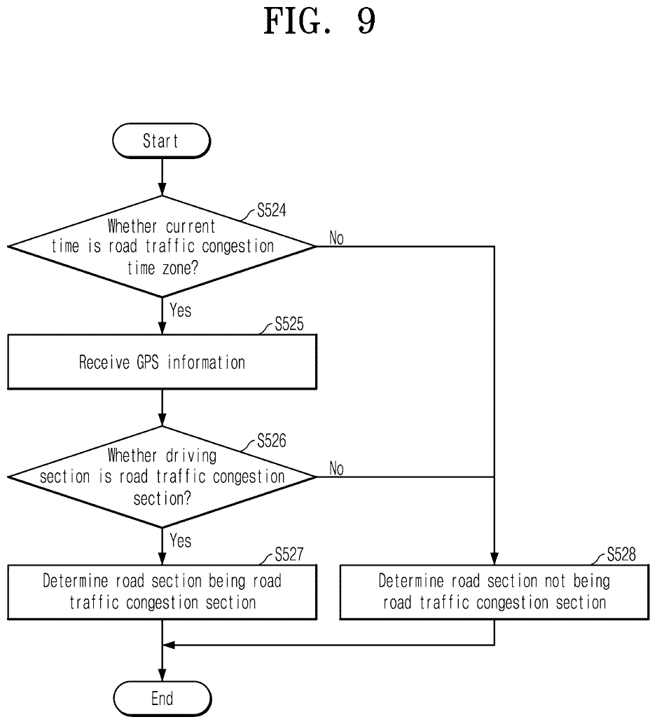

As the activation condition of the beam pattern light amount reduction control mode is satisfied, the lamp control system 10 may determine whether a driving section on which the moving object 1000 currently drives is a road traffic congestion section (S520). Whether or not a road section is a road traffic congestion section may be determined based on the average driving speed of the moving object 1000 on the road section or the average driving speed of all moving objects on the road section. Alternatively, whether a road section is the road traffic congestion section may be determined based on a time taken for the moving object 1000 to pass through the road section or an average time taken for all moving objects to pass through the road section. Determination of the road traffic congestion section will be described below with reference to FIG. 7 or 9.

The driving section on which the moving object 1000 drives needs to be determined to be the road traffic congestion section before a subsequent procedure may proceed.

When the driving section on which the moving object 1000 drives is determined to be the road traffic congestion section, the lamp control system 10 may be configured to reduce and control the beam pattern light amount according to a degree of road traffic congestion (S530).

The beam pattern light amount may be reduced more as the road traffic congestion section becomes more intense (severe). This is because the use of low beams is limited in the road traffic congestion section. Carbon emissions may also be reduced by controlling the amount of light. There is an advantage in that a discharge amount (or usage amount) of a secondary battery is reduced in the case of a moving object using the secondary battery by controlling the amount of light to decrease.

FIG. 6 is a flowchart illustrating a first method for determining whether an activation condition of a beam pattern light amount reduction control mode is satisfied according to the present disclosure. The illustrated determination of the activation condition of the beam pattern light amount reduction control mode may be performed by the lamp control system 10 or the moving object 1000 including the lamp control system 10. For simplicity of explanation, the method illustrated below is described as being performed by the lamp control system 10.

The lamp control system 10 may be configured to receive navigation information of the moving object 1000 (S511). The navigation information may include at least one of a starting point, a destination, or a waypoint of an expected driving route of the moving object 1000.

The lamp control system 10 may be configured to determine whether at least one of the navigation information, for example, the starting point or the destination, corresponds to a specific location (S512). For example, it may be determined whether the destination is a workplace of a user of the moving object 1000.

The lamp control system 10 may determine that the activation condition of the light amount reduction control mode for beam pattern light amount control is satisfied when at least one of the navigation information corresponds to a specific location (S513). As such, the use of the navigation information to determine the activation condition of the light amount reduction control mode for controlling the light amount of the beam pattern is to identify the driving pattern or style of the moving object 1000 or the user of the moving object 1000 by using the navigation information and provide light amount reduction control of the beam pattern accordingly.

The lamp control system 10 may determine that the activation condition of the light amount reduction control mode for beam pattern light amount control is not satisfied when at least one of the navigation information does not correspond to a specific location (S514).

As such, the beam pattern light amount reduction control mode according to the present disclosure may be activated or not activated based on the navigation information of the moving object 1000.

FIG. 7 illustrates a flowchart of a first method for determining whether a driving section is a road traffic congestion section according to the present disclosure. The illustrated method for determining whether the driving section is the road traffic congestion section may be performed by the lamp control system 10 or the moving object 1000 including the lamp control system 10. For simplicity of explanation, the method illustrated below is described as being performed by the lamp control system 10.

The lamp control system 10 may be configured to obtain an average driving speed of a road section on which the moving object 1000 drives and determine whether the obtained speed is less than a reference speed (S521).

The lamp control system 10 may be configured to determine that the driving road section of the moving object 1000 is a road traffic congestion section when the obtained speed is lower than the reference speed (S522).

The lamp control system 10 may be configured to determine that the driving road section of the moving object 1000 is not a road traffic congestion section when the obtained speed is not lower than the reference speed (S523).

In S521, the “average driving speed” is presented as a single determination reference, but determination may involve a plurality of pieces of information. Determination of the plurality of pieces of information may be configured to operate in parallel, and thus when the determination or reference on any one of the plurality of pieces of information is satisfied, the road section on which the moving object 1000 drives is determined to be a road traffic congestion section.

The lamp control system 10 may be configured to determine whether an average inter-moving object distance on a road section on which the moving object 1000 drives is less than a reference distance. If the average inter-moving object distance is less than the reference distance, the road section on which the moving object 1000 drives may be determined to be a road traffic congestion section.

The lamp control system 10 may be configured to determine whether an average number of moving objects ahead on the road section on which the moving object 1000 drives exceeds a reference distance. If the average number of moving objects ahead exceeds a reference number, the road section on which the moving object 1000 drives may be determined to be a road traffic congestion section.

When the average driving speed, the average inter-moving object distance, or the average number of moving objects ahead are used as a reference for determining whether the road section on which the moving object 1000 drives is a road traffic congestion section, the beam pattern light amount may be controlled to be lower as the average driving speed of the moving object is lower, the average inter-moving object distance during driving of the moving object is shorter, or the average number of moving objects ahead during driving of the moving object is higher.

FIG. 8 is a flowchart illustrating a second method for determining whether an activation condition of a beam pattern light amount reduction control mode is satisfied according to the present disclosure. The illustrated determination of the activation condition of the beam pattern light amount reduction control mode may be performed by the lamp control system 10 or the moving object 1000 including the lamp control system 10. For simplicity of explanation, the method illustrated below is described as being performed by the lamp control system 10.

Unlike FIG. 6, FIG. 8 uses received driving record analysis data.

The lamp control system 10 may receive from the server the driving record analysis data (S5110). The driving record analysis data may be received not only from the server, but also from an infrastructure such as surrounding moving objects or road side units (RSU).

The lamp control system 10 may be configured to check whether the received driving record analysis data contains information related to road traffic congestion related to the road section on which the moving object 1000 drives (S5120). The method for determining the activation condition of the light amount reduction control mode for controlling the light amount of the beam pattern in FIG. 8 does not use analysis data of the driving record of the moving object 1000, but rather uses information on the road traffic congestion section collected and analyzed from the driving record of other moving objects. Therefore, whether the driving record analysis data received by the moving object 1000 or the lamp control system 10 contains information related to road traffic congestion on the road section on which the moving object 1000 drives is used as an activation condition.

If the received driving record analysis data contains information related to road traffic congestion related to the road section on which the moving object 1000 drives, the lamp control system 10 may determine that the activation condition of the light amount reduction control mode for controlling the light amount of the beam pattern is satisfied (S5130).

If the received driving record analysis data does not contain information related to road traffic congestion related to the road section on which the moving object 1000 drives, the lamp control system 10 may determine that the activation condition of the light amount reduction control mode for controlling the light amount of the beam pattern is not satisfied (S5140).

With reference to FIGS. 6 and 8, satisfaction of the activation condition for the light amount reduction control mode for controlling the light amount of the beam pattern has been described, but according to the present disclosure, as the activation condition for the light amount reduction control mode for controlling the light amount of the beam pattern, information on the driver driving environment of various moving objects may be utilized.

That is, if the driving environment of the user or driver of the moving object corresponds to a specific driving environment, it may be determined that the activation condition for the light amount reduction control mode for controlling the light amount of the beam pattern is satisfied. For example, if a passenger ratio from the driver driving environment information exceeds a preset ratio, it may be determined that the activation condition for the light reduction control mode for controlling the light amount of the beam pattern is satisfied.

FIG. 9 illustrates a flowchart of a second method for determining whether a driving section is a road traffic congestion section according to the present disclosure. The illustrated method for determining whether the driving section is the road traffic congestion section may be performed by the lamp control system 10 or the moving object 1000 including the lamp control system 10. For simplicity of explanation, the method illustrated below is described as being performed by the lamp control system 10.

The lamp control system 10 may be configured to check whether the current time is a road traffic congestion time zone (S524). The road traffic congestion time zone may be a preset time zone, for example between 7:00 a.m. and 9:00 a.m., corresponding to rush hour. Alternatively, the road traffic congestion time zone may be set to a road traffic congestion time zone indicated in the received driving record analysis data.

The current time needs to be confirmed as a road traffic congestion time zone before a subsequent procedure may proceed.

The lamp control system 10 may be configured to receive global positioning system (GPS) information (S525). However, when determining the activation condition for the light amount reduction control mode for controlling the light amount of the beam pattern, if the location information of the moving object 1000, i.e., the information on the road section on which the moving object 1000 currently drives, is obtained, the current operation may be omitted.

The lamp control system 10 may be configured to determine whether the road section on which the moving object 1000 currently drives is a road traffic congestion section (S526). This may be determined based on the received driving record analysis data. For example, when information such as Table 1 is received as driving record analysis data, the degree of road traffic congestion may be obtained based on the current time and the road section on which the moving object 1000 drives.

The lamp control system 10 may be configured to determine that a current road section is a road traffic congestion section when the received driving record analysis data indicates a degree of road traffic congestion on the currently driving road section (for example, referring to Table 1, when the degree of congestion is “high” or “medium”) (S527).

The lamp control system 10 may be configured not to determine that a current road section is a road traffic congestion section when the received driving record analysis data does not indicate a degree of road traffic congestion on the currently driving road section (for example, referring to Table 1, when the degree of congestion is “low”) (S528).

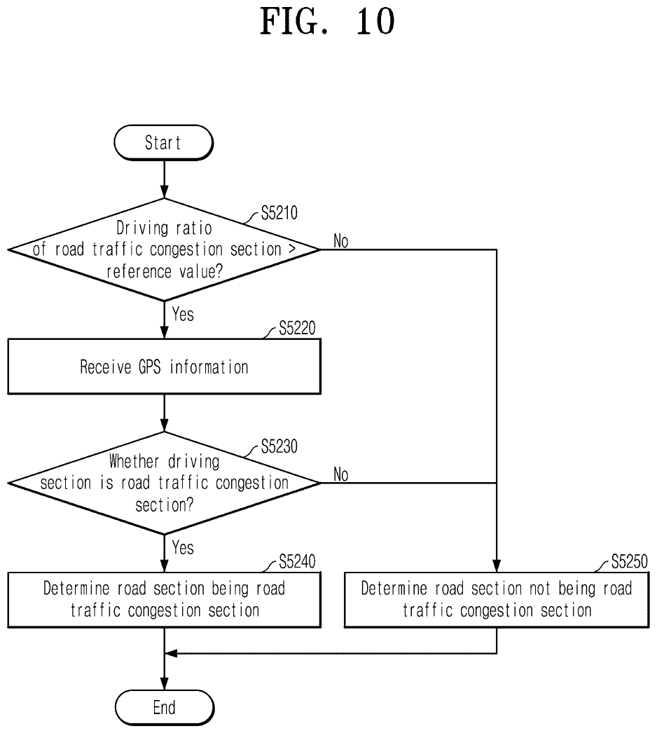

FIG. 10 illustrates a flowchart of a third method for determining whether a driving section is a road traffic congestion section according to the present disclosure. The illustrated method for determining whether the driving section is the road traffic congestion section may be performed by the lamp control system 10 or the moving object 1000 including the lamp control system 10. For simplicity of explanation, the method illustrated below is described as being performed by the lamp control system 10.

The lamp control system 10 may be configured to determine whether the driving ratio in a road traffic congestion section exceeds a reference value (S5210). From the received driving record analysis data, the driving ratio of the moving object 1000 in the road traffic congestion section may be obtained. For example, information such as Table 2 may be obtained.

Once it is confirmed that the driving ratio in the road traffic congestion section exceeds a reference value, a subsequent procedure may proceed.

The lamp control system 10 may be configured to receive global positioning system (GPS) information (S5220). However, when determining the activation condition for the light amount reduction control mode for controlling the light amount of the beam pattern, if the location information of the moving object 1000, i.e., the information on the road section on which the moving object 1000 currently drives, is obtained, the current operation may be omitted.

The lamp control system 10 may be configured to determine whether the road section on which the moving object 1000 currently drives is a road traffic congestion section (S5230). This may be determined based on the received driving record analysis data. For example, when information such as Table 1 is received as driving record analysis data, the degree of road traffic congestion may be obtained based on the current time and the road section on which the moving object 1000 drives.

The lamp control system 10 may be configured to determine that a current road section is a road traffic congestion section when the received driving record analysis data indicates a degree of road traffic congestion on the currently driving road section (for example, referring to Table 1, when the degree of congestion is “high” or “medium”) (S5240).

The lamp control system 10 may be configured not to determine that a current road section is a road traffic congestion section when the received driving record analysis data does not indicate a degree of road traffic congestion on the currently driving road section (for example, referring to Table 1, when the degree of congestion is “low”) (S5250).

The contents of the present disclosure described with reference to FIGS. 1 to 2 and FIGS. 4 to 10, which are not described with reference to FIG. 3, may be applied to the lamp control system 10 or the processor 610 thereof.

According to another embodiment of the present disclosure, a moving object or moving object 1000 including the lamp control system 10 described above is proposed.

In the above specification, the “system” for adjusting a light amount of the beam pattern or each component included therein is described as performing control, but the “device”, “system” and the components included therein are only names and the scope of rights is not dependent on thereon.

In other words, the proposed technology of the present disclosure may be performed by devices having names other than the processor, controller, etc. In addition, the method, scheme, or the like described above may be performed by software or code readable by a computer or other machine or device for lamp control.

In addition, as another aspect of the present disclosure, the operation of the proposed technology described above may be provided as code that may be implemented, realized, or executed by a “computer” (a generic concept including a system on chip (SoC) or a (micro) processor) or a computer-readable storage medium, a computer program product, or the like storing or containing the code. The scope of the present disclosure is extendable to the code or the computer-readable storage medium or the computer program product storing or containing the code.

Detailed descriptions of preferred embodiments of the present disclosure disclosed as described above have been provided such that those skilled in the art may implement and realize the present disclosure.

Although the present disclosure has been described above with reference to preferred embodiments, those skilled in the art will understand that various modifications and changes can be made to the present disclosure set forth in the claims below.

Accordingly, the present disclosure is not intended to be limited to the embodiments shown herein but is to be accorded the widest scope consistent with the principles and novel features disclosed herein.

The present disclosure has the following effects.

The present disclosure may control the amount of light in the beam pattern of the lamp.

The present disclosure may increase the concentration of a driver or reduce fatigue by controlling the amount of light in the beam pattern of the lamp.

The present disclosure may limit carbon emissions by controlling the amount of light in the beam pattern of the lamp.

The effects of the present invention are not limited to the effects described above. Other effects not described above may be understood by those of skill in the art from the description of the present disclosure below.

What is claimed is:

1. A lamp control system for a moving object, comprising:
a lamp configured to emit a beam pattern; and
a processor configured to adjust a light amount of the beam pattern depending on a degree of road traffic congestion,
wherein the processor is configured to control the light amount of the beam pattern to be lower as the degree of road traffic congestion increases.

2. The lamp control system of claim 1, wherein the processor is configured to initiate adjustment of the light amount of the beam pattern when a set destination of navigation for the moving object is a specific location.

3. The lamp control system of claim 1, wherein the processor is configured to initiate adjustment of the light amount of the beam pattern based on a current time being within a road traffic congestion time zone and a road section on which the moving object drives being a road traffic congestion section, and
information on the road traffic congestion time zone and the road traffic congestion section is obtained based on driving data of a plurality of moving objects.

4. The lamp control system of claim 1, wherein the processor is configured to obtain a driving ratio in a road traffic congestion section based on driving record analysis data of the moving object, determine whether the driving ratio in the road traffic congestion section exceeds a reference value, and initiate adjustment of the light amount of the beam pattern based on the driving ratio in the road traffic congestion section exceeding the reference value.

5. The lamp control system of claim 4, wherein the processor is configured to control the light amount of the beam pattern to be lower as a driving speed of the moving object decreases.

6. The lamp control system of claim 5, wherein a degree of reduction in the light amount of the beam is set to be greater as the driving ratio in the road traffic congestion section becomes higher.

7. The lamp control system of claim 1, wherein the processor is configured to determine whether there is the road traffic congestion or the degree of road traffic congestion based on any one of an average driving speed of the moving object, an average inter-moving object distance during driving of the moving object, and an average number of moving objects ahead during driving of the moving object.

8. The lamp control system of claim 7, wherein the processor is configured to control the light amount of the beam pattern to be lower as the average driving speed of the moving object becomes lower, the average inter-moving object distance during driving of the moving object becomes shorter, and the average number of moving objects ahead during driving of the moving object becomes higher.

9. A lamp control method for a moving object, which is performed by a lamp control system including a lamp configured to emit a beam pattern, the lamp control method comprising:
obtaining a degree of road traffic congestion; and
controlling a light amount of the beam pattern to be lower as the degree of road traffic congestion increases.

10. The lamp control method of claim 9, further comprising initiating adjustment of the light amount of the beam pattern when a set destination of navigation for the moving object is a specific location.

11. The lamp control method of claim 9, further comprising initiating adjustment of the light amount of the beam pattern based on a current time being within a road traffic congestion time zone and a road section on which the moving object drives being a road traffic congestion section,
wherein information on the road traffic congestion time zone and the road traffic congestion section is obtained based on driving data of a plurality of moving objects.

12. The lamp control method of claim 9, further comprising:
obtaining a driving ratio in a road traffic congestion section based on driving record analysis data of the moving object;
determining whether the driving ratio in the road traffic congestion section exceeds a reference value; and
initiating adjustment of the light amount of the beam pattern based on the driving ratio in the road traffic congestion section exceeding the reference value.

13. The lamp control method of claim 12, further comprising controlling the light amount of the beam pattern to be lower as a driving speed of the moving object decreases.

14. The lamp control method of claim 13, wherein a degree of reduction in the light amount of the beam is set to be greater as the driving ratio in the road traffic congestion section becomes higher.

15. The lamp control method of claim 9, further comprising
determining whether there is the road traffic congestion or the degree of road traffic congestion based on any one of an average driving speed of the moving object, an average inter-moving object distance during driving of the moving object, and an average number of moving objects ahead during driving of the moving object.

16. The lamp control method of claim 15, further comprising controlling the light amount of the beam pattern to be lower as the average driving speed of the moving object becomes lower, the average inter-moving object distance during driving of the moving object becomes shorter, and the average number of moving objects ahead during driving of the moving object becomes higher.

17. A moving object comprising:
a lamp configured to emit a beam pattern; and
a lamp control system including a processor configured to adjust a light amount of the beam pattern depending on a degree of road traffic congestion,
wherein the processor is configured to control the light amount of the beam pattern to be lower as the degree of road traffic congestion increases.

18. The moving object of claim 17, wherein the processor is configured to initiate adjustment of the light amount of the beam pattern when a set destination of navigation for the moving object is a specific location.

19. The moving object of claim 17, wherein the processor is configured to initiate adjustment of the light amount of the beam pattern based on a current time being within a road traffic congestion time zone and a road section on which the moving object drives being a road traffic congestion section, and
information on the road traffic congestion time zone and the road traffic congestion section is obtained based on driving data of a plurality of moving objects.

20. The moving object of claim 17, wherein the processor is configured to obtain a driving ratio in a road traffic congestion section based on driving record analysis data of the moving object, determine whether the driving ratio in the road traffic congestion section exceeds a reference value, and initiate adjustment of the light amount of the beam pattern based on the driving ratio in the road traffic congestion section exceeding the reference value.
